(19) United States
(12) Patent Application Publication
(10) Pub. No.: US 2024/0140727 A1
(43) Pub. Date: May 2, 2024

(54) Method And Multi-Level Switchback Conveyor Apparatus For Product Singulation And Alignment

(71) Applicant: Automated Industrial Technologies, Inc., Forest, VA (US)

(72) Inventors: David Raymond SCHLUETER, Madison Heights, VA (US); Matthew JOHNSON, Lynch Station, VA (US)

(73) Assignee: Automated Industrial Technologies, Inc., Forest, VA (US)

(21) Appl. No.: 18/385,066

(22) Filed: Oct. 30, 2023

Related U.S. Application Data
(60) Provisional application No. 63/420,140, filed on Oct. 28, 2022.

(51) Int. Cl. B65G 47/31; B65G 47/14; B65G 47/244

(52) U.S. Cl. CPC B65G 47/31; B65G 47/1492; B65G 47/244; B65G 2201/0217

(57) ABSTRACT

A method and apparatus wherein a flow of elongated product, such as wooden boards, oriented transverse to the direction of travel; having abutted stacks or piles with numerous layers in a variously misaligned fashion, is received onto the first and uppermost of a series of generally horizontal conveyors arranged in a single vertical array one above the other with each subsequent level operating in a direction opposite of the level above it. The flow of product is transferred off the end of each conveyor into and through a gap between the conveyor and a declined reversal ramp system wherein gravity acts with the product's momentum to move it across and past a series of adjacent, planar surfaces angled relative to one another in the general direction of product travel such that the product is aligned more perpendicular to its travel, dispersed more into a single layer, and reversed in its direction of travel with each successive transition to the next lower conveyor resulting in a singulated, aligned array of pieces flowing onto the last and lower-most conveyor from which they are presented to a subsequent process or machine.

### RELATED APPLICATION

This application claims the benefit of U.S. Provisional Application Ser. No. 63/420,140, filed Oct. 28, 2022, entitled “Method And Multi-Level Switchback Conveyor Apparatus For Product Singulation And Alignment,” which is incorporated herein by reference in its entirety.

### FIELD OF THE INVENTION

This invention relates to the handling of elongated products, such as wooden boards. More particularly, the invention relates to a method and apparatus for separating and aligning such elongated products from a piled, disorderly overlayed, or otherwise superposed continuous supply.

### BACKGROUND OF THE INVENTION

The technical problem addressed by the invention is described below.

While the following discussion will frequently use the wood processing industry as just one example of applications suited for the presented invention, it is to be understood that many other industries and processes handling elongated products may also benefit from application of the invention with or without modifications of detail, rearrangement and/or multiplication or reduction of parts wherein the fundamental spirit, essence, or scope is that of the presented invention. In the wood processing industry examples used herein, the term “product” refers to wooden boards.

In the wood processing and material handling industry, it is standard practice for processing machines to be interconnected by way of conveyor systems. These conveyor systems serve several purposes a few of which are providing a grading surface for defective product to be removed, providing a metering surface where product can be spaced in a proper array and straightened before they enter a subsequent processing machine, and they can be used to guide product from one machine's exit elevation to another machine's entry elevation. In the lumber industry wood processing machines used to stack or process boards into dimensional products; sometimes with various machined features such as notches or grooves, typically require or at least perform most efficiently when the boards are presented to such machines in a singulated, aligned, and orderly fashion. With the more variation and defects in the processed products (general lower grade or quality boards) the more problematic it is for conveyor systems to accomplish the desired presentation. In the lumber industry even with “good” quality boards, conveyors commonly must be manned by workers whose job is to simply monitor boards that are entering the next machine to ensure the boards are singulated and enter at the desired orientation and to correct them as needed. Manning conveyors adds cost and limits the processing speed. In many cases, to increase production speed or reduce the required manpower but still avoid the added complications that arise when transferring and positioning lower quality boards, such as those having significant amounts of wane as shown in the example in FIG. 1, these lower quality boards are not accepted into a process. While it is desired to reduce the number of workers required to run different operations so they can be utilized elsewhere in the process, there is a growing cost associated with the avoidance of processing lower quality yet useable boards. Ultimately process improvements are needed to both reduce the required manpower, increase processing speed, and increase the capability of the process to handle cheaper more available materials.

The wood processing and material handling industry have developed to include several standard machine types which aim to aid in the presentation of singulated, aligned and orderly product thus allowing for more efficient production. One of the most important of these machine types is the unscrambler machine which takes its name from its function. The unscrambler takes the product which is piled in a hopper and slowly dispenses it in intervals onto a belt or chain conveyor system to produce a singulated, aligned array of product. FIG. 2 gives an example of an unscrambler machine and its function. As can be seen in FIG. 2, boards are placed in the unscrambler hopper and a set of chains, on which are fastened special lugs, cleats, or flights (at intervals), rotate and pull boards out of the hopper and up the curved incline “ramp” to the top of the unscrambler. While the unscrambler ideally has flights just wide enough to support the edge surface of a single piece of product to ensure it presents aligned and singulated product to the downstream process, product with tapered or wedge-shaped or generally varying cross-section profiles (such as low-grade boards with significant wane) are not easily picked up and supported by the edge surface. Therefore, to process this type of product the flights must be deeper as compared to the product thickness which results in a higher rate of product presented from the unscrambler aligned but still in groups of two or three pieces. Methods exist to start and stop the unscrambler machine to ensure product presentation is “metered” out at a steady rate; however, the small groups are often not dispersed, and the stop/start cycling significantly reduces the overall processing speed. Other methods and options for addressing such singulation issues are known and are sometimes incorporated in place of or in series with an unscrambler as described in attempt to singulate such product; however, each of the other methods have significant drawbacks.

Some of the other methods for singulating elongated product and their respective drawbacks are:
(a) Manual Assisted Singulation—this is labor intensive, requires additional manpower, increases the operating cost, and limits the processing speed;
(b) Holdback Mechanisms such as disclosed in U.S. Pat. No. 4,116,323 which discloses an apparatus for conveying objects one by one. Holdback mechanisms can become a bottleneck creating a growing pileup that either requires manual intervention or at some point the pileup will overcome the holdback mechanism resulting in a surge of product into downstream operations. A rearwardly shingled or scaled flow of product can become wedged/jammed under a holdback mechanism and stop flow completely and/or damage the transfer equipment. This problem increases in frequency with certain product cross-section profiles (such as low-grade boards with significant wane);
(c) A Series of Inclined, Declined, or Vertically Offset (stepped) Conveyors such as disclosed in U.S. Pat. No. 6,491,154 which discloses an unstacker for unstacking items conveyed in a bulk stream; or U.S. Pat. No. 11,097,903 which discloses a board conveyor apparatus for use in a board processing system. A series of conveyors with any arrangement of inclination, declination, or vertical offsets takes up a significant amount of floor space as each transition from one conveyor to another only slightly improves the positioning and grouping or spacing of the product. Many of these systems also incorporate the use of sensors and a control system to stop, start, or change the speeds of each conveyor with respect to its fore and aft conveyors at the precise moment a piece of product or group of products transitions from one conveyor to the next as a means to significantly improve the positioning and grouping or spacing of the product. Control systems are more complex and expensive and the stop/start cycling significantly limits the overall processing speed;
(d) S-shaped Board Unscramblers such as disclosed in U.S. Pat. No. 6,401,906 which discloses an unscrambler machine with an upwardly and forwardly extending S-shaped curvilinear conveyor having a rearward horizontal portion to receive scrambled boards, a middle uprising portion to unscramble and align the boards, and a horizontal forward portion to deliver the boards uses chain mounted flights to engage and move boards up the inclined surface just as the previously described unscrambler. While the middle uprising portion achieves a steeper angle for better singulation which allows for relatively deeper flights to better engage and lift product with tapered or wedge-shaped and generally varying cross-section profiles; it still relies on product falling on one side or the other of a very fine line between near perfect balance of a single board standing vertically on its edge and a doubled board becoming unstable and falling off as they are carried up the incline; and
(e) Automated Systems such as disclosed in U.S. Pat. No. 6,471,044 which discloses a hold and release singulator. Automated systems come in all kinds of forms and are capable of performing all kinds of intricate and complex tasks; however, they are relatively complex even in their simplest forms which means they are a more expensive investment upfront and are more expensive to maintain and repair. Although some systems can be quite fast, many of these systems do not provide continuous forward processing which ultimately limits overall processing speed.

Accordingly, the closest related art describes a series of forward running conveyors with an arrangement of inclination, declination, or vertical offsets (steps). As seen above, these apparatuses have various shortcomings. These and other shortcomings of these apparatus are addressed by the present invention.

### SUMMARY OF THE INVENTION

The present invention is directed to a method and an apparatus to singulate and align elongated objects such as wood boards in an efficient and less expensive manner than the prior art devices by use of a multi-level switchback conveyor.

A primary object of the present invention is to provide a method and apparatus for singulating and aligning elongated objects which takes up significantly less floor space compared to the known devices.

Another primary object of the present invention is to provide a method and apparatus for singulating and aligning elongated objects which provides for more accurate and guaranteed singulation and alignment of the elongated objects.

Another primary object of the present invention is to provide a method and apparatus for singulating and aligning elongated objects which provides a continuous forward processing of all pieces of the elongated product.

Another primary object of the present invention is to provide a method and apparatus for singulating and aligning elongated objects which apparatus can run at a higher speed as compared to the known devices.

Another primary object of the present invention is to provide a method and apparatus for singulating and aligning elongated objects which singulates and aligns low-quality or low grade elongated objects such as wood boards.

Another primary object of the present invention is to provide a method and apparatus for singulating and aligning elongated objects which apparatus is simple in design and easy to operate and maintain at a reasonable cost.

Another primary object of the present invention is to provide a method and apparatus for singulating and aligning elongated objects which apparatus does not require an automated control system.

The present invention is directed to an apparatus for singulating and aligning elongated product oriented transverse to its direction of travel. The apparatus comprises a ramp system (311) which is positioned at the downstream end of an upstream conveyor or machine (36) such that the ramp system acts on the transferred product as it reaches the end of the upstream equipment and as it transitions off of and falls away from the end of the upstream equipment. The ramp system (311) includes two or more adjacent, planar surfaces (3111, 3112), wherein each planar surface is generally perpendicular to a vertical plane through the centerline of the product's path of travel up to and off of the downstream end of the upstream equipment and each planer surface has a first end (31111, 31121) and a second end (31112, 31122) by which the product travels passed the first end prior to the second end. The first end (31111) of the first of the adjacent planar surfaces (3111) is positioned at an elevation (D1) of two or more product thicknesses above the downstream end of the upstream equipment. The second end (31112) of the first planar surface (3111) is positioned a horizontal distance (D3) beyond its first end and beyond the downstream end of the upstream equipment in the direction of the products travel, at an elevation equal to or less than that of the downstream end of the upstream equipment resulting in an angle (A1) less than 90 degrees between the first planar surface (3111) and the product support surface of the upstream equipment. The first end (31121) of the second of the adjacent planar surfaces (3112) is positioned adjacent to the second end (31112) of the first planer surface. The second end (31122) of the second planar surface (3112) is positioned a vertical distance below its first end and horizontally such that the resulting angle (A) between the second planar surface (3112) and the first planar surface (3111) is greater than 90 degrees and less than 180 degrees. Subsequent adjacent planar surfaces are positioned and oriented relative to its respective preceding planar surface according to the same relation between the second planar surface and the first planar surface.

There is further disclosed a method for singulation and alignment of elongated product oriented transverse to its direction of travel. The method includes the steps of transferring the product off the end of a conveyor; allowing gravity to act with the product's momentum to maintain motion, increase speed, and alter its path of travel; allowing a bottom-most layer of the product in a more desirable position and orientation to enter an unimpeded freefall upon leaving the conveyor, thus allowing more acceleration due to gravity relative to pieces of product in less desirable positions and orientations, likewise creating more space between the individual pieces of said bottom-most layer of product as they fall; and delaying acceleration of any pieces of product in less desirable positions and orientations to reposition and reorient the pieces of product such that they either move into the spaces created by the unimpeded freefall of the bottom-most product layer, or at least into a more favorable position and orientation as they fall.

These primary and other objects of the invention will be apparent from the following description of the preferred embodiments of the invention and from the accompanying drawings.

### BRIEF DESCRIPTION OF THE DRAWINGS

The following detailed description of the specific non-limiting embodiments of the present invention can be best understood when read in conjunction with the following drawings, where like structures are indicated by like reference numbers.

Referring to the drawings:

FIG. 1 is a perspective view of two example boards, one of high grade with a near perfectly shaped rectangular cross-sectional profile and one of a lower grade or a lower quality with significant amounts of wane creating a cross-sectional profile closer to that of a trapezoid as opposed to a rectangle.

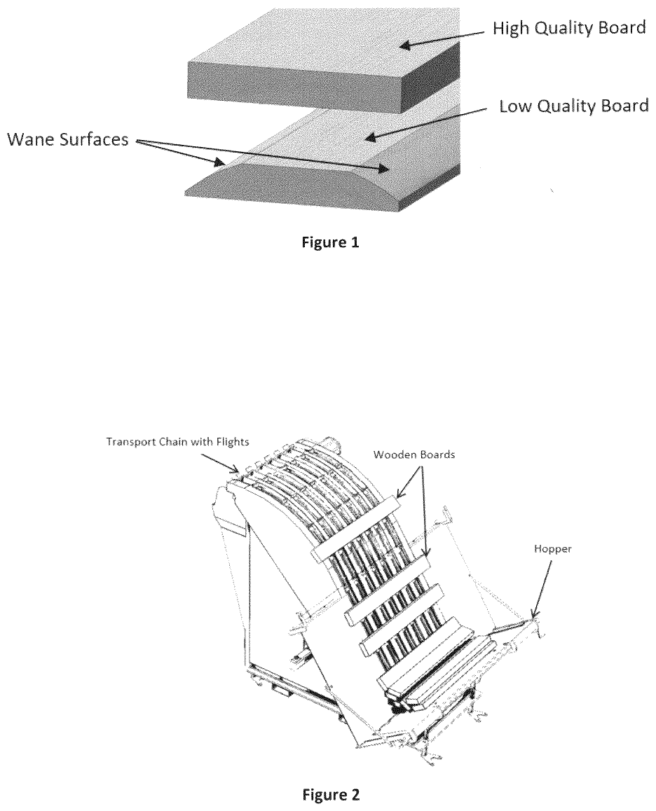

FIG. 2 is a perspective view of a typical unscrambler used in the lumber industry to singulate and align boards.

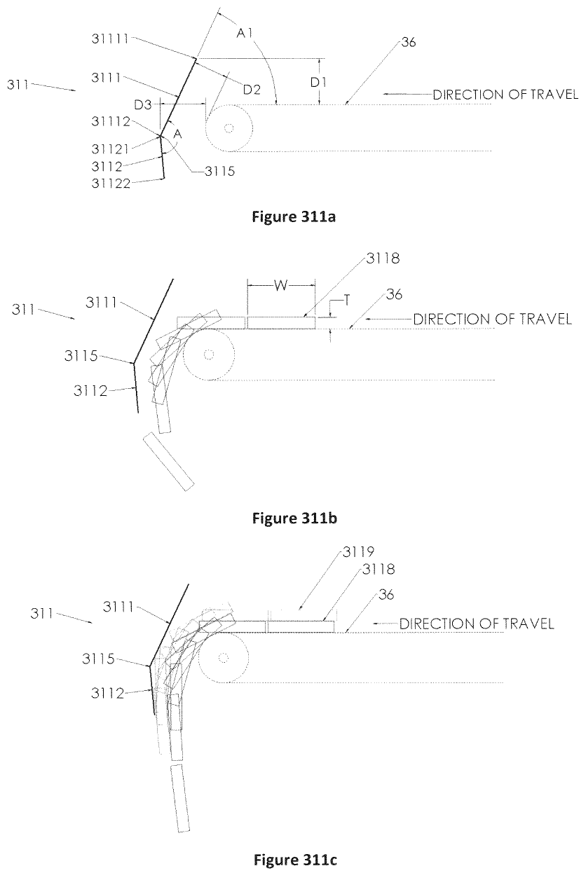

FIG. 311a is a side elevation view embodiment of a declined ramp system.

FIG. 311b is a side elevation view embodiment of a declined ramp system and the stepped path of a single layer product's travel showing how the ramp system acts on the product as it leaves one conveyor and moves into freefall.

FIG. 311c is a side elevation view embodiment of a declined ramp system and the stepped path of a doubled layer product's travel showing how the ramp system acts on the product as it leaves one conveyor and moves into freefall.

FIGS. 311d, 311e, and 311f are side elevation view embodiments of a declined ramp system with different product arrangements at the breakover point on the conveyor.

FIG. 31a is a side elevation view embodiment of a declined reversal ramp system and conveyor.

FIG. 31b is a side elevation view embodiment of a declined reversal ramp system and the stepped path of a doubled layer product's travel showing how the ramp system acts on the product as it leaves one conveyor and moves toward the next.

FIG. 3a is a side elevation view embodiment of a Multi-Level Switchback Conveyor System of the present invention.

FIG. 3b is a perspective view embodiment of the Multi-Level Switchback Conveyor System of FIG. 3a.

### DETAILED DESCRIPTION OF THE PREFERRED EMBODIMENTS

The Multi-Level Switchback Conveyor System invention is described hereafter. The invention is described through an example embodiment thereof. This example embodiment is intended to be considered as exemplary only, with the fundamental spirit, essence, and scope of the invention defined in the appended claims. With consideration of the features and specifications detailed herein other embodiments of the presented invention will be apparent to those skilled in the art.

Although the method of positioning a conveyor between two processing machines is not new, an invention of an apparatus and method is presented herein for utilizing a multi-level switchback conveyor apparatus as shown, for example, in FIGS. 3a and 3b between an upstream processing machine like a split saw or an unscrambler machine and a downstream processing machine such as a notching machine, trim saw, stacking machine, or other feeding mechanism. The presented invention allows for the processing of very low-quality boards at a high rate while also eliminating or significantly reducing the problems and drawbacks common to currently known transfer, singulation, and positioning methods and machines. The specifics of each aspect of this method will be described in detail below.

The presented invention accepts a continuous flow of groups of product either directly from a processing machine such as a saw or an unscrambler machine or from a simple conveyor. Accepting groups of product means the unscrambler can be designed with flights wide enough to support the width surface of the product; so that tapered or wedge-shaped and generally varying product cross-section profiles (such as low-grade boards with significant wane) are consistently carried out of the hopper, without concern of singulating the product at the same time. The product is deposited onto the uppermost conveyor (36) of the presented invention transverse to (its longest dimension perpendicular to) the direction of travel by various transitional means from the upstream machine such as a drop or fall, a smooth slide, roller-ways (35), etc. The uppermost conveyor (36) of the presented invention is generally horizontal and powered such that it carries the product in a forward direction at a speed independent of the upstream machine. The product (3118) is transferred off the end of the uppermost conveyor (36) through a gap between said conveyor and the first declined reversal ramp system (311).

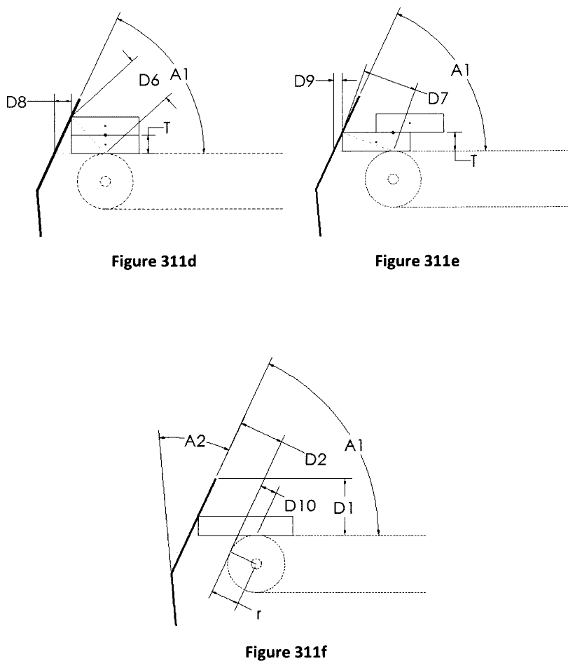

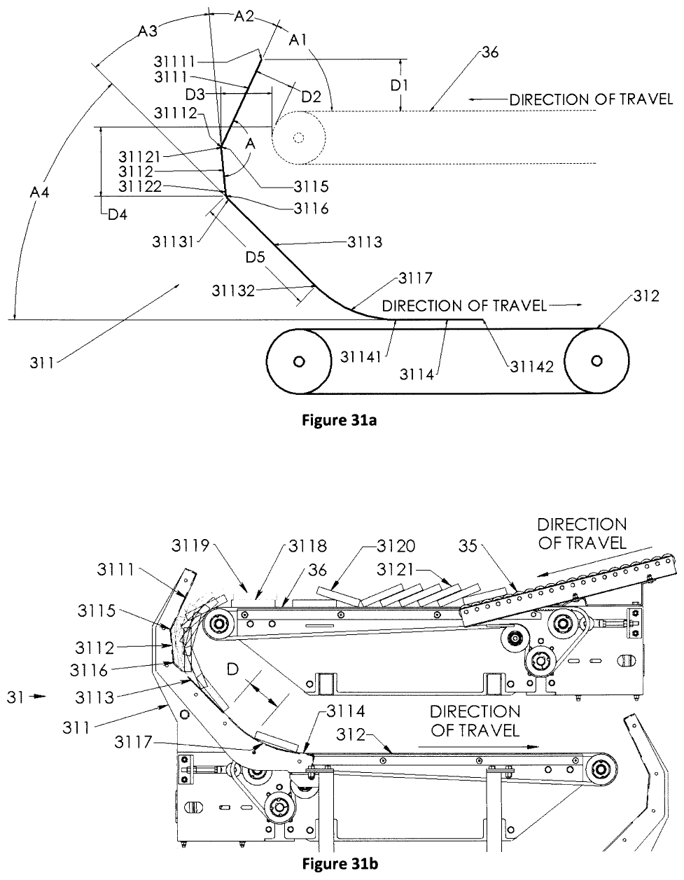

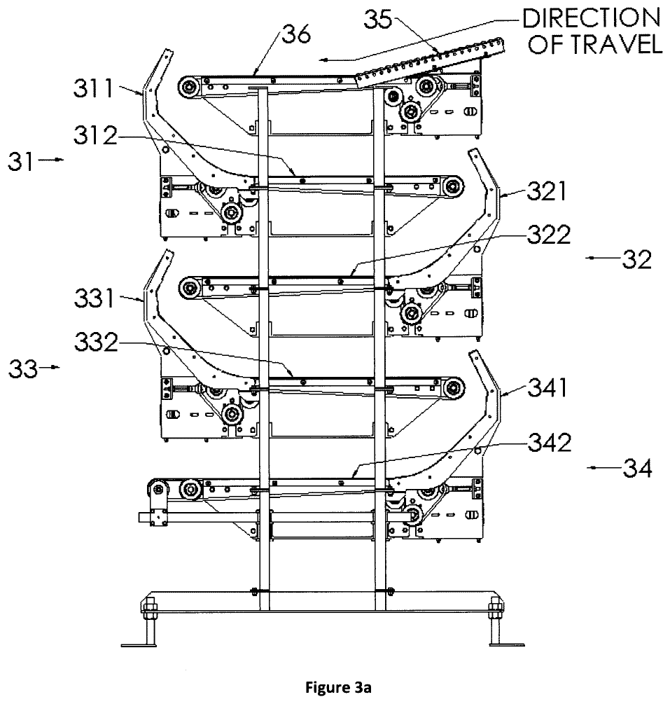

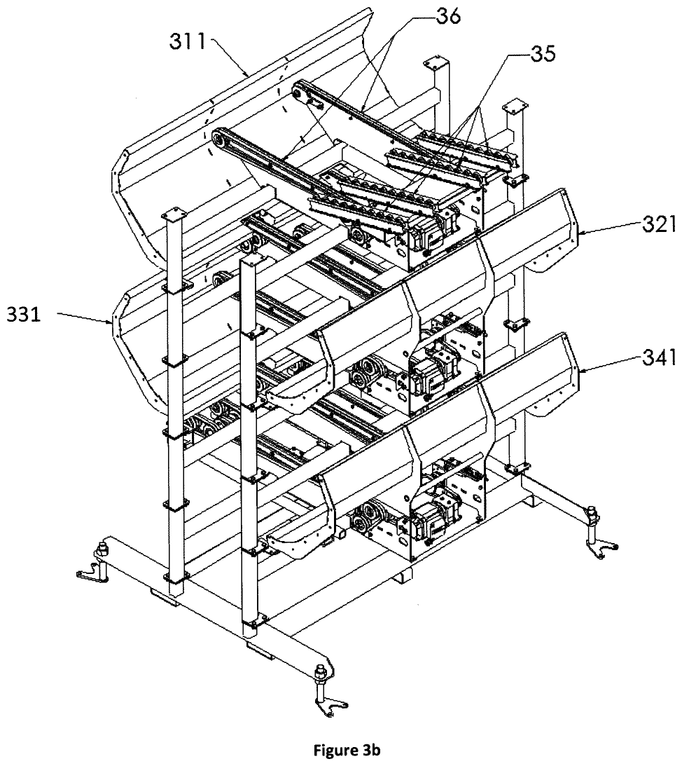

The presented invention's declined reversal ramp system (311) consists of a series of adjacent, planar surfaces (3111, 3112, 3113, 3114) angled relative to one another in the general direction of product travel and having some transitions between said surfaces being of an abrupt nature (3115, 3116) and other transitions (3117) between said surfaces being of a smooth nature such as a curved tangentially aligned surface. Such a ramp system can be of a fixed or adjustable design for changing: the gap distance (D2) between the planar surfaces and the conveyor, or for changing the angles of inclination of the planar surfaces relative to one another (A) or relative to horizontal (A1), or for changing both the gap distances and the angles of inclination. The angled surfaces making up the upper to middle regions of the ramp system are positioned and declined such that they are somewhat tangent to the downward curved path taken by the leading edge of a single piece of product (3118) which is aligned with its long edge perpendicular to its direction of travel and is not influenced by other product as it is projected from the end of the conveyor and falls under the effects of gravity as shown in FIG. 311b. As the trailing edge of the single piece of product leaves the conveyor the product tends to rotate about a horizontal axis with the leading edge moving in a near vertical downward direction and the trailing edge moving forward in a generally horizontal direction as the product falls under the effects of gravity. With such induced rotation in the single piece of product as it falls through the middle region and onto the lower region of the ramp system, the leading edge contacts the ramp and is directed into a more horizontal rearward direction of travel as shown in FIG. 31b. The trailing edge then contacts the ramp and continues trailing relative to the new direction of product travel with the product now flipped into an up-side-down orientation. Due to the accelerating force of gravity during the free fall, the first single piece of product momentarily opens or increases space (D) between itself and any subsequent pieces. The angled surfaces making up the upper to middle regions of the ramp system positioned and declined as just described act on single (unstacked) pieces of product only when the product is not aligned perpendicular to the direction of travel wherein such case the leading end of the skewed product contacts the first encountered ramp surface and is delayed slightly in its forward movement allowing the trailing end to catch up thus improving the alignment. This delaying of the leading end of the product continues to occur at each of the abrupt ramp surface transitions until the product is sufficiently perpendicular to its travel such that its entire length contacts the remaining transitions in a parallel fashion.

When product arrives on the uppermost conveyor in a stacked (3119) or piled (3120, 3121) arrangement wherein there is a bottom piece or pieces in contact with the conveyor creating a first layer (3118), and there are additional pieces positioned above and supported by each piece directly below it creating a second, and possibly additional layers, the first piece projected from the conveyor in the first layer travels very near the same path as a single piece of product as previously described. The second (3119) and subsequent layers ride on the first layer pieces in a generally horizontal path until they contact the first declined surface (3111) of the ramp system (311) at which point, they are delayed in their forward movement allowing the first layer pieces to advance forward relative to the other layers as shown in FIG. 31b. This advancement allows the first layer piece to become free to fall before the second layer piece creating a momentary open space (D) between pieces of the first layer. As the first layer piece travels through its near natural path, the leading edge of the second layer piece starts to move in a more downward direction with any third or subsequent layers following. The third or subsequent layers moving somewhat parallel to the first contacted ramp surface (3111) also contact the next angled surface (3112) where it is again delayed allowing the second layer piece to advance forward relative to the other upper layers and start to increase its speed under the accelerating force of gravity. As the upper layers of the first “stack” fall through the gap, the second “stack” of pieces are pushed into the gap in a similar fashion as the first. Pieces in the lower layers of the second stack may pass in front of the upper layers of the first stack and filter into the spaces opened up as the pieces of the first stack undergo the effects of unimpeded acceleration and delayed acceleration respectively. Passage through the first declined reversal ramp system (311) dissipates the majority of the stacked or piled pieces into a mostly single layer as the product transfers onto and engages the second conveyor (312).

The second conveyor (312) of the presented invention is generally horizontal and powered such that it carries the product in a rearward direction at a speed independent of the uppermost conveyor (36). The product is transferred off the end of the second conveyor through a gap between said conveyor and the second declined reversal ramp system (321). The second declined reversal ramp system can be similar or identical to the first declined reversal ramp system (311). The function is essentially the same as the first in that it acts on product to align its long edge perpendicular to its path of travel, delays the upper pieces in any remaining stacks or piles to disperse the product further into a single layer, and reverses the direction of travel. Passage through the second declined reversal ramp system dissipates nearly all the remaining stacked or piled pieces into a single layer as the product transfers onto and engages the third conveyor (322).

The third conveyor (322) of the presented invention is generally horizontal and powered such that it carries the product in a forward direction at a speed independent of the second conveyor (312). The product is transferred off the end of the third conveyor through a gap between said conveyor and the third declined reversal ramp system (331). The third declined reversal ramp system can be similar or identical to either; or both, of the first two declined reversal ramp systems. The function of the third declined reversal ramp system is essentially the same as that of the first two in that it acts on product to align its long edge perpendicular to its path of travel, delays the upper pieces in any remaining stacks or piles to disperse the product even further into a single layer, and reverses the direction of travel. Passage through the third declined reversal ramp system leaves nearly 100% of the product in a single layer as it transfers onto and engages the fourth conveyor (332).

The fourth conveyor (332) of the presented invention is generally horizontal and powered such that it carries the product in a rearward direction at a speed independent of the third conveyor (322). The product is transferred off the end of the fourth conveyor (332) through a gap between said conveyor and the fourth declined reversal ramp system (341). The fourth declined reversal ramp system can be similar or identical to any; or all, of the first three declined reversal ramp systems. The function of the fourth declined reversal ramp system is essentially the same as the first three in that it acts on product to align its long edge perpendicular to its path of travel, delays the upper pieces in any remaining stacks or piles to disperse the product into a single layer, and reverses the direction of travel. Passage through the fourth declined reversal ramp system is mainly to achieve the same forward direction of travel as the product had when first engaging the uppermost conveyor of the presented invention but it also serves to reduce the possibility of unsingulated product passing through the process to an absolute minimum. As the product leaves the fourth declined reversal ramp system it travels onto and engages the fifth conveyor (342) the speed of which can be increased as desired to create or increase a permanent gap between pieces of product at this transition before they are presented to the next machine downstream.

While one specific configuration of the declined reversal ramp system (311) will perform acceptable alignment and singulation of some range of product cross section dimensions and some range of conveyor (36) speeds; there are configuration changes that can optimize the performance for different target ranges of product size and speed. To define how the best configuration is determined some terminology must first be defined.

Breakover Distance (BD)—The diagonal distance from the top corner of the piece of product; which would first contact the first planar surface, to the bottom face directly under its effective center of gravity. This is the maximum distance beyond Top Dead Center (TDC) of the end conveyor roller that the leading edge of a piece of product can extend as its center of gravity passes TDC and it begins to move downward. Two potentially worst-case scenarios are evaluated. Referring to FIG. 311d, one scenario assumes there are two stacked pieces of same sized product vertically aligned and the distance (D6) is pulled from the top corner of the second layer piece. Referring to FIG. 311e, another scenario assumes there are two stacked pieces of same sized product offset by 50% of its width and the distance (D7) is pulled from the top corner of the first layer piece.

$$D 6 = \sqrt{{( 2 T )}^{2} + {( \frac{W}{2} )}^{2}}$$

$$D 7 = \sqrt{{( T )}^{2} + {( \frac{3 W}{4} )}^{2}}$$

Point of Contact Compensation (POCcomp)—The distance; measured parallel to the conveyor; from the intersection of the conveyor top plane and the first planar surface to the leading edge of a piece of product in contact with the first planar surface. The same two scenarios assumed for the Breakover Distance are assumed for this calculation.

$$D 8 = \frac{2 T}{tan ( A 1 )} ( vertically aligned per D 6 scenario )$$

$$D 9 = \frac{T}{tan ( A 1 )} ( 50 \% offset per D 7 scenario )$$

Throat (D2)—The point of the narrowest gap between the first planar surface and the end of the conveyor (36).

Breakover Distance to Throat Compensation (D10)—Referring to FIG. 311f, the distance; measured perpendicular to the first planar surface, from the end of the throat to the Top Dead Center (TDC) of the end conveyor

$$D 10 = \frac{( r ) sin ( A 1 )}{sin ( \frac{180 ° - ( A 1 )}{2} )} cos ( \frac{180 ° - ( A 1 )}{2} )$$

The minimum required Throat for each potential worst-case breakover distance scenario along with the minimum required to pass two simultaneous pieces of stacked product is calculated and the greater of the values plus a 12% buffer is then applied as the actual minimum D2ₘᵢₙ for that particular size product.

Throat minimum based on the vertically aligned D6 scenario=D6+D8−D10

Throat minimum based on the 50% offset D7 scenario=D7+D9−D10

Throat minimum to pass two pieces of stacked product=2T

The maximum Throat is calculated based on the degree of acceptable misalignment of product passing off the conveyor (36). This is the distance parallel to the conveyor center plane from the top corner of the leading edge on the leading end of a piece of product to the bottom face directly under its center of gravity. Where a is the maximum angle of misalignment between a plane perpendicular to the direction of travel and the leading edge of a piece of product as it begins to roll over and off the end of the conveyor and L is the product length, the maximum Throat is calculated by:

$$D {2}_{max} = \sqrt{{T}^{2} + {( ( \frac{W}{2} + ( \frac{L}{2} ) tan ( α ) ) cos ( α ) )}^{2}} + D 9.$$

According to the Conveyor Equipment Manufacturers Association (CEMA) the speed condition for a conveyor is defined by

$$\frac{{V}_{s}^{2}}{g {R}_{c}}$$

where Vₛ is the tangential velocity, g is gravity, and R_{c} is the radius from the center of the conveyor head (end) pulley to the centroid of the material. When the speed condition is greater than or equal to 1 a high-speed condition exists and when less than 1 a low-speed condition exists. In low-speed conditions the transferred material will ride around the pulley before discharge or leaving contact with the conveyor; whereas, in high-speed conditions the transferred material discharges at the conveyors tangent point of the belt to pulley. Since the low-speed condition results in longer contact with the conveyor end pulley, a piece of product will begin to angle downward while still in contact with the conveyor which helps to transition product orientation and direction of travel without contacting the first planar surface (3111) and before reaching the Throat. Since the smaller the R_{c} value is, the larger the speed condition value; and R_{c} is dependent on the product thickness, the worst-case speed condition should be calculated using the thinnest product to be processed. The conveyor speed or size of the conveyor end pulley should be adjusted to achieve a low-speed condition with the thinnest product.

Not all the many parameters that define the configuration of the declined reversal ramp system are highlighted in the described embodiment. However, the relationship between some parameters and the performance of the ramp system are discussed herein. The distance (D1) of the first end (31111) of the first planar surface above the conveyor (36) should be determined based on the product thickness (T) and the extent to which the product is metered from the upstream machine. The less product is metered the more layers or taller piling are possible. D1 should be set greater than the anticipated maximum total height of the product flow and will therefore not require adjustment as it will extend above all shorter product flows. In cases of the anticipated maximum total height being less than half the product width (W); D1 should be greater than half of that width (W) to prevent product which is standing on edge from being projected over the ramp system.

The distance (D2) between the first planar surface (3111) and the conveyor (36) is a primary parameter to be adjusted to help accommodate conveyor speed change and product width (W) change. The higher the conveyor speed or the wider the product the greater will be the horizontal element of its leading edge's trajectory after it leaves the conveyor. D2 should be increased for faster conveyor speeds or wider product or decreased for slower conveyor speeds or narrower product such that a single layer of product, which is aligned with its long edge perpendicular to its direction of travel, comes within one product thickness (T) of the planar surface but does not contact it as the product leaves the conveyor and falls. For low-speed conditions the acceptable range for D2 for a given product cross section can be calculated using the equations for D2ₘᵢₙ and D2ₘₐₓ discussed above. The larger D2 is for a given product thickness (T), width (W) and speed, the greater extent the product can be misaligned as it begins to fall. Product falling while still severely misaligned will cause jamming.

Another important parameter is the angle (A1) of the first planar surface relative to the conveyor (36). The smaller this angle the more the product is deflected downward on contact and the less delay is achieved. This reduces the effective alignment of misaligned product since the leading end is not significantly delayed before it is deflected downward which can cause the trailing end to be raised off the conveyor (36) at which point it can block subsequent product from free entry into the gap (D2). If angle A1 is too great the upper layers of stacked or piled product will not be sufficiently deflected downward and will tend to stop moving or even bounce backward after contact causing jamming.

Another important parameter is the angle (A4) of the third planar surface (3113) relative to horizontal. This angle needs to be a minimum of 40° to provide acceptable acceleration of the product under the force of gravity as it slides downward. If this angle is too great it will cause product with squarer (width to thickness ratio greater than 0.5) cross sections to roll down the decline instead of sliding and maintaining the proper orientation. Another reason to limit this angle (A4) is to allow the angle (A3) between the second planar surface (3112) and the third planar surface (3113) and the angle (A2) between the first planar surface (3111) and the second planar surface (3112) to be set between 30° to 45° which is the range that provides a sufficient delaying effect without causing excessive bouncing of the product as it crosses the delaying transitions (3115, 3116).

Another important parameter is the vertical distance (D4) from the first end (31131) of the third planar surface (3113) to the centerline of the end roller of the conveyor (36). This distance (D4) is minimum freefall distance which should be between one to one and a half times the product width to allow sufficient acceleration of pieces of product in the bottommost layer without resulting in excessive bounce when product contacts the third planar surface.

Equally important is the horizontal distance (D3) between first end (31131) of the second planar surface (3113) and the tip of the conveyor (36). This distance like distance D2 is also a primary parameter to be adjusted to help accommodate conveyor speed change and product width (W) change. Again, the higher the conveyor speed or the wider the product the greater will be the horizontal element of its leading edge's trajectory after it leaves the conveyor. Just like distance D2, distance D3 should be increased for faster conveyor speeds or wider product or decreased for slower conveyor speeds or narrower product such that a single layer of product; which is aligned with its long edge perpendicular to its direction of travel, comes within one product thickness (T) of the planar surface but does not contact it as the product falls. The minimum D3 should be 125% of distance D2. The larger D3 becomes for a given product thickness (T), width (W), and speed, the less the force normal to the second planar surface (3112) will be upon contact with undesirably positioned or oriented product. The less force normal to the surface the less delay of these pieces will be achieved.

Yet another important parameter is the distance (D5) which is the distance between the first and second ends of the third planar surface (3113). This distance should be a minimum of twice the product width (W) to allow a gap (D) equivalent to one product width to be created between a leading piece of product and a subsequent piece of product of the same layer before they reach the transition (3117) onto the fourth and final planar surface (3114). This gap accommodates delayed pieces of product so they can filter into a single layer.

The depicted embodiment has a configuration with the following parameters: A1=65°, A2=30°, A3=40°, A4=45°, D1=4.5 inches, D2=3.5 inches, D3=4.7 inches, D4=6 inches, D5=11 inches. This configuration accommodates wooden boards of cross-sectional dimensions ⅜ inch thick by 2 inches wide; ⅜ inch thick by 5½ inches wide; ¾ inch thick by 5½ inches wide with an entry speed of approximately 150 feet per minute.

Although other embodiments of the presented invention could have fewer, more, or essentially any number of levels, the described embodiment of the presented invention has four levels (31, 32, 33, 34). Any even number of levels will ultimately maintain the original direction of travel of the product while any odd number of levels will ultimately reverse the direction of product travel. Some products may be satisfactorily singulated using less levels while some products may require more; however, generally the more levels incorporated the lower the rate of passing unsingulated product.

Each of the conveyors depicted in the presented embodiment are comprised of two parallel belts both of which are driven by a common shaft/drive system. Each drive system can be set to run its respective conveyor at a common speed, or they can be set to run different speeds in any variety of arrangements. It is noted that matching or varying the conveyor speed relative to the speed of the product exiting each respective ramp system can significantly affect the effectiveness of singulation as well as product orientation.

While the described embodiment of the presented invention does not describe an automated controls system, it is to be understood that a controls system could be incorporated to manipulate any number of parameters; such as but not limited to conveyor speeds, positioning or declination of the ramp system or individual angled surfaces, inclination of conveyors, metering the rate at which product is presented to the presented invention, etc., without departing from the fundamental spirit, essence, or scope of the presented invention. Likewise, although the presented invention has been described in connection with an example embodiment thereof, it will be appreciated by those skilled in the art that additions, deletions, modifications, and substitutions not specifically described herein may be made without departing from the fundamental spirit, essence, or scope of the invention as defined in the appended claims.

It is claimed:

1. A method for singulation and alignment of elongated product oriented transverse to its direction of travel, the method comprising the steps of:
transferring the product off the end of a first conveyor;
allowing gravity to act with the product's momentum to maintain motion, increase speed, and alter its path of travel;
allowing a bottom-most layer of the elongated product in a more desirable position and orientation to enter an unimpeded freefall upon leaving said first conveyor, thereby allowing more acceleration due to gravity relative to pieces of elongated product in less desirable positions and orientations, thereby creating more space between the individual pieces of said bottom-most layer of elongated product as they fall;
delaying acceleration of any pieces of elongated product in less desirable positions and orientations to reposition and reorient said pieces of elongated product such that they either move into the spaces created by the unimpeded freefall of the bottom-most elongated product layer, or at least into a more favorable position and orientation as they fall.

2. The method of claim 1, further comprising the step of redirecting the falling elongated product toward a generally horizontal path of travel.

3. The method of claim 2, wherein the direction of horizontal travel is in the opposite direction from that of the first conveyor.

4. The method of claim 1, further comprising the step of engaging and transferring the elongated product on a subsequent second conveyor in the opposite direction from that of the first conveyor.

5. The method of claim 4, wherein:
a first of two or more cycles, begins with the step of transferring of the elongated product off the end of the first conveyor, includes the steps of allowing gravity to act on the elongated product as it falls and redirecting the falling elongated product toward a generally horizontal direction of travel opposite that of the first conveyor, and ends with the step of engaging of the elongated product with the subsequent second conveyor; and
a subsequent cycle begins with the step of transferring the elongated product off the end of the subsequent second conveyor and repeats the steps of the first cycle ending with the step of engaging the elongated product with yet another subsequent third conveyor.

6. The method of claim 5, wherein each subsequent cycle transfers the product in a direction opposite of the previous cycle and a last and lowermost conveyor engages and transfers the singulated, aligned array of pieces of elongated product for presentation to a subsequent process or machine.

7. An apparatus for singulating and aligning elongated product oriented transverse to its direction of travel, said apparatus comprising:
a ramp system (311) which is positioned at the downstream end of an upstream equipment (36) such that said ramp system acts on the transferred elongated product as it reaches said end of an elongated product support surface of the upstream equipment and as it transitions off of and falls away from said end of the upstream equipment;
said ramp system (311) comprising two or more adjacent, planar surfaces (3111, 3112), wherein each planer surface is generally perpendicular to a vertical plane through the centerline of the elongated product's path of travel up to and off of said downstream end of the upstream equipment and each planer surface has a first end (31111, 31121) and a second end (31112, 31122) by which the elongated product travels passed the first end prior to the second end;
the first end (31111) of the first of said adjacent planar surfaces (3111) is positioned at an elevation (D1) of two or more elongated product thicknesses above the downstream end of said upstream equipment;
the second end (31112) of said first planar surface (3111) is positioned a horizontal distance (D3) beyond the first end of the first planar surface and beyond the downstream end of said upstream equipment in the direction of the elongated product's travel, at an elevation equal to or less than that of the downstream end of said upstream equipment resulting in an angle (A1) less than 90 degrees between said first planar surface (3111) and the elongated product support surface of said upstream equipment;
the first end (31121) of the second of said adjacent planar surfaces (3112) is positioned adjacent to the second end (31112) of said first planer surface;
the second end (31122) of said second planar surface (3112) is positioned a vertical distance below the first end of the second planar surface and horizontally such that the resulting angle (A) between the second planar surface (3112) and the first planar surface (3111) is greater than 90 degrees and less than 180 degrees; and
wherein optionally subsequent adjacent planar surfaces are positioned and oriented relative to their respective preceding planar surface according to the same relation between the second planar surface and the first planar surface.

8. The apparatus of claim 7, wherein:
said adjacent planar surfaces are each distanced away from and angled relative to said upstream equipment according to the speed of said upstream equipment and the range of combinations of product widths (W) and respective thicknesses (T) such that a relatively aligned, single layer of the elongated product (3118) can pass through a resulting gap with only enough contact to divert its direction of travel to the desired direction thereby having more speed and distance of unimpeded freefall relative to pieces of elongated product in less desirable positions or orientations (3119); pieces of the elongated product in a single layer that are misaligned contact said adjacent planar surfaces only enough to improve the elongated product's alignment and divert its direction of travel to the desired direction thereby minimally affecting its speed and distance of unimpeded freefall; pieces of the elongated product undesirably positioned or oriented such that they protrude above the thickness of a single layer of the elongated product such as pieces stacked (3119), piled (3120), in a shingled or scaled array (3121), or otherwise superposed on a first bottommost layer of the elongated product contact said adjacent planar surfaces significantly such that these undesirably positioned or oriented pieces of elongated product are slowed or delayed in their travel with the slowing or delaying effect being greater relative to a piece's position or protrusion above the thickness of a single layer being greater, thus causing a variable rate of repositioning of the undesirably positioned or oriented pieces relative to the pieces in the first bottommost layer as they are aligned and diverted to the desired direction of travel;
said adjacent planar surfaces having transitions between each planar surface ranging from abrupt with sharp vertices at the intersection for greater impedance to product flow, to gradual and smooth with curved, tangentially aligned, transitional surfaces between each plane for less disturbance of product flow and orientation;
said range of transition types are arranged with more abrupt transitions (3115, 3116) higher in the ramp system wherein contact is almost entirely from the undesirably positioned or oriented pieces, and with transitions (3117) becoming more gradual the lower in the ramp system they are positioned where increasing contact occurs from pieces of product from a single or bottommost layer and repositioned pieces.

9. The apparatus of claim 7, wherein said ramp system comprises:
four adjacent, planar surfaces (3111, 3112, 3113, 3114);
an abrupt transition (3115), a semi-smooth transition (3116), and a very smooth transition (3117);
a total angular change, summing the angle between the first planar surface and the elongated product support surface of said upstream equipment (A1) plus the angle between the second planar surface and said first planar surface (A2) plus the angle between the third planar surface and said second planar surface (A3) plus the angle between the fourth planar surface and said third planar surface (A4), equaling approximately 180 degrees such that the falling elongated product is redirected back toward a generally horizontal path of travel in a direction opposite from that of said upstream equipment.

10. The apparatus of claim 7, further comprising a first conveyor which engages and transfers the elongated product in a direction opposite from that of said upstream equipment (312).

11. The apparatus of claim 10, wherein:
a first (31) of two or more levels comprises said ramp system (311) and said first conveyor (312);
a second level (32) comprises a subsequent second ramp system (321) and a subsequent second conveyor (322); each subsequent third and fourth levels (33, 34) comprises subsequent third and fourth ramp systems (331, 341) and third and fourth conveyors (332, 342).

12. The apparatus of claim 11, wherein:
the second (32) and each subsequent third and fourth levels (33, 34) is arranged in a single vertical array one above the other with each level operating in a direction opposite of the level above it;
the last and lowermost fourth level (34) presents the singulated and aligned array of pieces of elongated product to a subsequent process or machine.

13. An apparatus for singulating and aligning elongated product, said apparatus comprising:
a generally horizontal conveyor (36) to receive product from an upstream equipment, where said elongated product is received in an orientation transverse to its direction of travel;
said conveyor (36) having a first end and a second end with a direction of product travel being from the first end to the second end;
a ramp system (311) positioned at the second end of said conveyor;
said ramp system (311) comprising two or more adjacent, planar surfaces (3111, 3112, 3113, 3114), wherein each planer surface is generally parallel to the axis of rotation of the end of said conveyor and has a first end and a second end by which the product travels passed the first end prior to the second end;
the first end (31111) of the first of said adjacent planar surfaces (3111) is positioned at an elevation (D1) of two or more elongated product thicknesses above the second end of said conveyor;
the second end (31112) of said first planar surface (3111) is positioned a horizontal distance (D3) beyond the first end of the first planar surface and beyond the second end of said conveyor in the direction of the products travel, at an elevation equal to or less than that of the second end of said conveyor resulting in an angle (A1) less than 90 degrees between said first planar surface (3111) and the conveying surface of said conveyor (36);
the first end (31121) of the second of said adjacent planar surfaces (3112) is positioned adjacent to the second end (31112) of said first planer surface;
the second end (31122) of said second planar surface (3112) is positioned a vertical distance below the first end of the second planar surface and horizontally such that the resulting angle (A) between the second planar surface (3112) and the first planar surface (3111) on said conveyor side of the two planar surfaces is greater than 90 degrees and less than 180 degrees; and
wherein optionally subsequent adjacent planar surfaces (3113, 3114) are positioned and oriented relative to their respective preceding planar surface according to the same relation between the second planar surface and the first planar surface.

14. The apparatus of claim 13, further comprising a non-horizontal transitional means from the upstream equipment wherein the upstream equipment presents the product at an elevation above that of said conveyor (36) such that the product transitions onto said conveyor by methods such as a drop or fall, a smooth downward slide, roller-ways (35), or any combination of the same.

15. The apparatus of claim 13, wherein:
said adjacent planar surfaces (3111, 3112, 3113, 3114) are each distanced away from and angled relative to said conveyor according to the speed of said conveyor and the range of combinations of elongated product widths (W) and respective thicknesses (T) such that; a relatively aligned, single layer of the elongated product (3118) can pass through a resulting gap with only enough contact to divert its direction of travel to the desired direction thereby having more speed and distance of unimpeded freefall relative to pieces of elongated product in less desirable positions or orientations (3119); pieces of the elongated product in a single layer that are misaligned contact said adjacent planar surfaces only enough to improve the elongated product's alignment and divert its direction of travel to the desired direction thereby minimally affecting its speed and distance of unimpeded freefall; pieces of the elongated product undesirably positioned or oriented such that they protrude above the thickness of a single layer of the elongated product such as pieces stacked (3119), piled (3120), in a shingled or scaled array (3121), or otherwise superposed on a first bottommost layer of the elongated product contact said adjacent planar surfaces significantly such that these undesirably positioned or oriented pieces are slowed or delayed in their travel with the slowing or delaying effect being greater relative to a piece's position or protrusion above the thickness of a single layer being greater, thus causing a variable rate of repositioning of the undesirably positioned or oriented pieces relative to the pieces in the first bottommost layer as they are aligned and diverted to the desired direction of travel;
said adjacent planar surfaces having transitions between each planar surface ranging from abrupt (3115, 3116) with sharp vertices at the intersection for greater impedance to product flow, to gradual (3117) and smooth with curved, tangentially aligned, transitional surfaces between each plane for less disturbance of product flow and orientation;
said range of transition types are arranged with more abrupt transitions (3115, 3116) higher in the ramp system wherein contact is almost entirely from the undesirably positioned or oriented pieces, and with transitions (3117) becoming more gradual the lower in the ramp system they are positioned where increasing contact occurs from pieces of product from a single or bottommost layer and repositioned pieces.

16. The apparatus of claim 13, wherein said ramp system comprises:
four adjacent, planar surfaces (3111, 3112, 3113, 3114);
an abrupt transition (3115), a semi-smooth transition (3116), and a very smooth transition (3117);
a total angular change, summing the angle between the first planar surface and an elongated product support surface of said upstream equipment (A1) plus the angle between the second planar surface and said first planar surface (A2) plus the angle between the third planar surface and said second planar surface (A3) plus the angle between the fourth planar surface and said third planar surface (A4), equaling approximately 180 degrees relative to said conveyor such that the falling elongated product is redirected back toward a generally horizontal path of travel in a direction opposite from that of said conveyor.

17. The apparatus of claim 13, further comprising a second conveyor (312) which engages and transfers the product in a direction opposite from that of said conveyor.

18. The apparatus of claim 17, wherein:
a first (31) of two or more levels comprises said ramp system (311) and said second conveyor (312);
a second level (32) comprises a subsequent second ramp system (321) and a subsequent third conveyor (322);
each subsequent third and fourth levels (33, 34) comprises subsequent third and fourth ramp systems (331, 341) and fourth and fifth conveyors (332, 342).

19. The apparatus of claim 18, wherein:
the second (32) and each subsequent level (33, 34) is arranged in a single vertical array one above the other with each level operating in a direction opposite of the level above it;
the last and lowermost fourth level (34) presents the singulated and aligned array of pieces to a subsequent process or machine.

20. An apparatus for singulating and aligning elongated product oriented transverse to its direction of travel, the apparatus comprising
a vertical system including at least two vertically oriented levels, each level including a ramp and a conveyor,
a first level positioned at the downstream end of an upstream equipment such that a first ramp acts on a transferred elongated product as it reaches the end of the upstream equipment and falls away from the end of the upstream equipment and is received by the first ramp,
the first ramp comprises at least two adjacent planar surfaces adapted to singulate and align the elongated product,
the elongated product is transferred from the first ramp to a first conveyor on the first level adapted to move the elongated product to a second level,
the elongated product is adapted to move from the first conveyor to a second ramp of the second level,
the second ramp comprises at least two adjacent planar surfaces adapted to further singulate and align the elongated product, and
the elongated product is transferred from the second ramp to a second conveyor on the second level adapted to move the elongated product to optionally an additional level or to further processing equipment for the singulated and aligned elongated product.

21. The apparatus of claim 20 wherein the vertical system includes four levels.

22. The apparatus of claim 21 wherein the first and second ramps include four planar surfaces.

23. The apparatus of claim 22 wherein the transition between the first through fourth planar surface comprises an abrupt transition, a semi-smooth transition, and a very smooth transition, respectively.

24. The apparatus of claim 20 wherein the elongated product comprises wood boards.
